(19) United States
(12) Patent Application Publication
(10) Pub. No.: US 2019/0303961 A1
(43) Pub. Date: Oct. 3, 2019

(54) Merchant Referal Based Coustmer-Merchant Transaction System

(71) Applicant: REFERPLUS PRIVATE LIMITED, Pune, Maharashtra (IN)

(72) Inventors: Amol Vishwas Patankar, Pune (IN); Tushar Kamlakar Tajane, Pune (IN)

(21) Appl. No.: 16/341,499

(22) PCT Filed: Oct. 14, 2017
(86) PCT No.: PCT/IN2017/050472

§ 371 Date: Apr. 12, 2019

(30) Foreign Application Priority Data
Oct. 14, 2016 (IN) 201621035134

(51) Int. Cl. G06Q 30/02; G06Q 30/06; G06Q 20/20

(52) U.S. Cl. CPC G06Q 30/0214; G06Q 30/0633; G06Q 20/201; G06Q 30/0233; G06Q 30/0277; G06Q 30/0261

(57) ABSTRACT

The present invention relates to a customer loyalty and rewards platform establishment and management of operation. In an example embodiment, the system includes a platform having one or more modules and one or more databases corresponding to the respective modules. The merchants and customers both having one handheld device which are configured with the platform over a virtualized cloud-based system for distributed communication via a communication network. The platform includes a processor which is operable for automatically sending, activating, and redeeming one or more digital incentive for a financial amount by applying the financial amount as a credit or discount for a predetermined spend activity by the consumer at a registered merchant within the platform.

### FIELD OF THE INVENTION

The present invention relates to customer-merchant transaction systems and more particularly to a referral coupon based customer-merchant transaction system.

### BACKGROUND OF THE INVENTION

Merchant customer relationship is not only limited to physical shopping now days but it has evolved as web based shopping. The web based shopping introduces a method and a system of virtual shopping that facilitates buying and returning goods thereby actually eliminating the need of physically visiting the shops by the customer. Such methods and systems facilitate merchants to put offers, advertise and sell their goods to the customers situated at any part of the world without physical interaction. Customers may check quality, price and designs of the goods before purchasing them. These systems facilitate returning of goods on disapproval. There are few systems known in the art that facilitate the customer to win reward points based on shopping and convert them into cash for their next purchases.

Various attempts have been made to develop systems for web based shopping. For example, United States patent application number US20050144084 discloses a system for on-line shopping. The system detects and uses customer's purchasing interest analysed by his shopping behavior in past and present shopping events. Accordingly, the generated data is used for identifying and suggesting alternative items. Further, International patent publication number WO2010056862A1 discloses a system and a method for location-based online shopping and advertising. This system facilitates users to make offers or to solicit offers from vendors in a particular geographic area and for providing advertising to the users.

However, the methods and systems disclosed in the prior art fail to track customer shopping behavior, generating report based on various filters such as transactions, referrals, ranking, advertisement, suggestions, reward points and the like. The systems disclosed in the prior art fail to resolve complaints and grievances of customers. In addition, these prior art systems fail to disclose or suggest advertisement of the products by the merchants based on parameters such as numbers of referrals, review ratings, duration of shopping and the like.

Accordingly, there is a need of customer-merchant transaction system that finds registered merchants based on location or proximity by applying filters. Also, there is need of customer-merchant transaction system that views all relevant information published by the merchants or users. Further, there is need of customer-merchant transaction system that generates reports based on ranking/activities. In addition, there is need of customer-merchant transaction system that facilitates reward points based coupons that may be encased or utilized for various purposes by the customers/users of the system.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one aspect of the present invention is a transaction method of a customer with a merchant using a customer loyalty and rewards platform. The method including the steps of receiving a purchase request for at least one product from the customer by the merchant, checking the received request by the merchant, whether the customer is a registered user of the platform for availing the service of the platform, entering one or more information of the customer by the merchant in the platform, checking whether the customer is with a coupon or without a coupon for transacting the purchase request based on the information provided by the customer, assigning predefined discount for the transaction and provides predefined referral coupons through the portal, if the customer is performing a transaction without a coupon, and displaying available coupons with the customer for the corresponding merchant and provides further discount and/or referral coupons for distribution, if the customer is performing a transaction with a coupon.

In another aspect of the present invention relates to a method of pushing information to and receiving information to a target customers from a platform over a communication network. The method including the steps of receiving by the platform, from at least one merchant, an advertisement and conditions for publishing the advertisement to one or more customers, wherein the advertisement includes a plurality of questions about a brand or a product or likewise, getting one or more reward points to the customer for all correct answers, requesting the customer to share the advertisement message on various social media network to earn addition rewards as per the advertisement setting, and disabling the advertisement interaction with the customer once the advertisement message is shared.

In yet another aspect of the present invention relates to a system for customer loyalty and rewards platform establishment and management of operation. The system including the platform having a plurality of modules including a merchant module, an administration module, a customer module, a coupon module and a plurality of databases corresponding to the respective modules, a plurality of merchants and a plurality of customers both having at least one handheld device which are configured with the platform over a virtualized cloud-based system for distributed communication via a communication network, the platform is operable to receive inputs from at least one consumer user for creating a consumer and a merchant profile registered through the at least one processor and stored in a platform database, the consumer profile including at least a consumer username, contact information, and at least one consumer user payment account registered with the platform, the merchant profile including at least a merchant username, contact information, and at least one merchant recipient account registered with the platform, the processor operable for automatically sending, activating, and redeeming at least one digital incentive for a financial amount by applying the financial amount as a credit or discount for a predetermined spend activity by the consumer at a registered merchant within the platform.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the detailed description of the invention below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

For a more complete understanding of the present invention, and the advantages thereof, reference is now made to the following descriptions taken in conjunction with the accompanying drawings, wherein like numbers designate like objects, and in which:

FIGS. 1 and 2 is a system overview diagram of a customer-merchant transaction system in accordance with the present invention.

FIG. 3 shows a flow chart of a transaction method of a customer with a merchant using a customer loyalty and rewards platform, according to one embodiment of the present invention.

FIG. 4 shows an example flow chart of FIG. 3 where the customer does a transaction with a merchant for the first time and subsequent purchase, according to one embodiment of the present invention.

FIG. 5 shows a flow chart of a method of pushing information to and receiving information to a target customers from a platform over a communication network, according to one embodiment of the present invention.

FIG. 6 shows an example flow chart of utilization of credit points by the customers using the customer-merchant transaction system of FIG. 1, according to one embodiment of the present invention.

FIG. 7 shows an example flow chart of utilization of credit points for utility payments by the customer, according to one embodiment of the present invention.

FIG. 8 shows an example flow chart of allocation of system loyalty points, according to one embodiment of the present invention.

FIG. 9 shows an example flow chart of redemption of the credit points by the customer with respect to any merchant, according to one embodiment of the present invention.

FIG. 10 shows an example flow chart of conversion of merchant credit points, according to one embodiment of the present invention.

FIG. 11 shows an example flow chart of ranking process of the customer by the merchant, according to one embodiment of the present invention.

FIG. 12 shows an example flow chart of allocation of VIP referrer by the merchant, according to one embodiment of the present invention.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DESCRIPTION OF THE INVENTION

The invention described herein is explained using specific exemplary details for better understanding. However, the invention disclosed can be worked on by a person skilled in the art without the use of these specific details.

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The foregoing description of specific embodiments of the present invention has been presented for purposes of illustration and description. They are not intended to be exhaustive or to limit the present invention to the precise forms disclosed and obviously many modifications and variations are possible in light of the above teaching.

Accordingly, the present invention discloses a referral coupons and referral credits based transaction system between customers and merchants that rewards for providing successful sales. The system of the present invention is adapted to help facilitate physical shop owners, retailers, service providers, ecommerce marketplace portals and online retailers with an additional DIY marketing channel for their business.

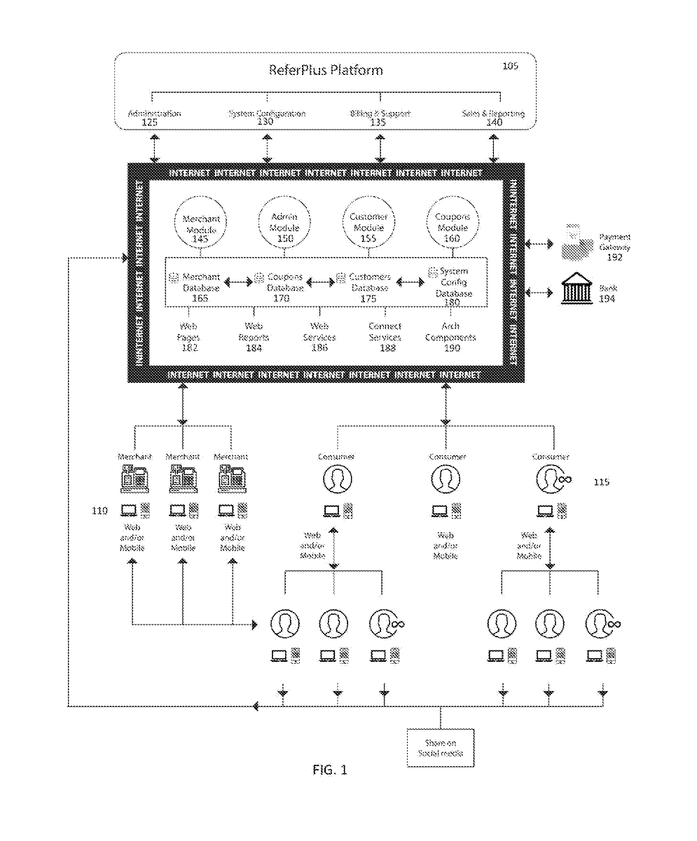

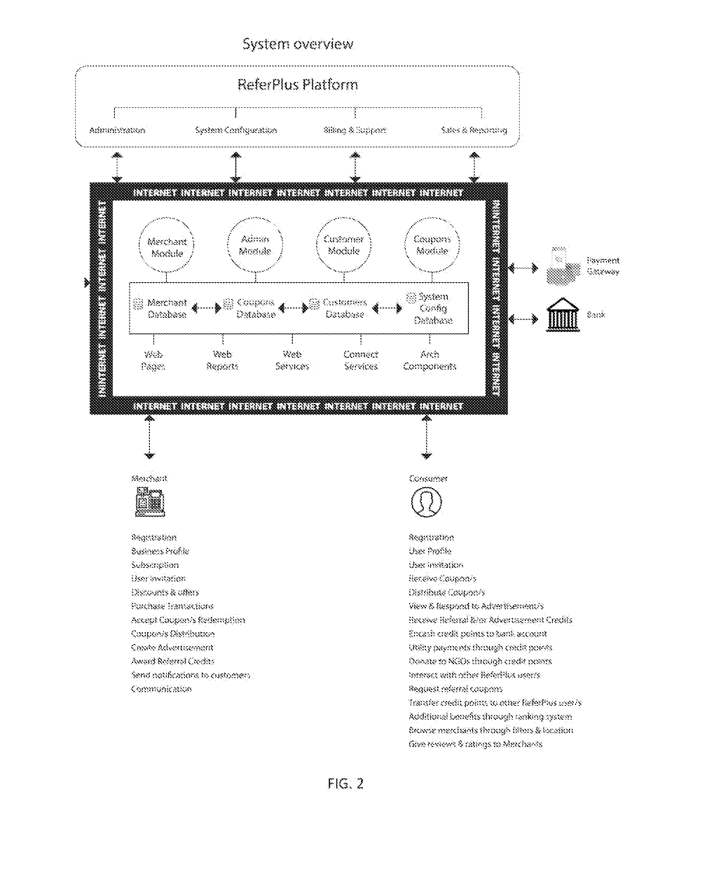

Referring to FIGS. 1 and 2, a system environment 100 tailored for transaction between the customers and merchants in accordance with the present invention is shown. The system environment 100 includes a referral platform 105 that is communication with a plurality of merchants 110 and a plurality of consumers/customers 115 through a customer-merchant transaction system 120. It is understood here that said communication between the plurality of merchants 110 and the plurality of consumers 115 is facilitated by a web/mobile application via internet as illustrated.

The referral platform 105 includes an administration module 125, a system configurator module 130, a billing and support module 135 and a sales and reporting module 140 that independently communicate with the customer-merchant transaction system 120 through an internet. The customer-merchant transaction system 120 includes a merchant module 145, an admin module 150, a consumer module 155 and a coupons module 160. The customer-merchant transaction system 120 also includes a plurality of databases namely a merchant database 165, a coupons database 170, a customer database 175 and a system database 180. The merchant module 145 is configured to store the merchant information in the merchant database 165. The admin module 150 is configured to store administration related information in the system database 180. The customer module is configured to store customer related information in the customer database 175. The coupons module 160 is configured to store referral coupons related information in the coupons database 170. The customer-merchant transaction system 120 is configured to include a plurality of web pages 182, a plurality of web reports 184, a plurality of web services 186, a plurality of connect services 188 and a plurality of architectural components 190. The customer-merchant transaction system 120 is also enabled with a payment gateway 192 and a banking service 194 as shown.

In the context of the present invention, the plurality of merchants 110 interact with the customer-merchant transaction system 120 for a plurality of services such as merchant registration, merchant business profile registration, merchant subscription, user invitation through merchant, discounts and offers through merchant, purchase transactions, acceptance/redemption of coupons, coupon distribution, advertisement of merchant, referral credit awards, sending notifications to customers through merchant and the like.

In the context of the present invention, the plurality of consumers 120 interact with the customer-merchant transaction system 120 for a plurality of services such as consumer registration, consumer user profile, user invitation, receiving coupons, distribution of coupons, viewing and responding to advertisements, receiving referral and/or advertisement credits, credit points encashment, utility payments through credit points, donation to NGOs through credit points, interaction with other users of the system, requesting referral coupons, transferring credit card points to other users of the system, providing additional benefits through ranking system, browsing merchants through filters and location, giving reviews and rating to merchants and the like.

In an embodiment, a user/consumer registration procedure in accordance with the present invention is described wherein the consumer can register with the customer-merchant transaction system 120 optionally via a self registration process or a registration through referral process. In the self registration process, the user downloads an App pertaining to the customer-merchant system 120 and installs the same followed by registration through his/her communication device. The customer-merchant system 120 may grant credit points to the user on sign up. Alternatively, the consumer may get registered with the customer-merchant system 120 through a referral wherein user gets referred through a coupon and receives an SMS. Subsequently, the user downloads application, installs, registers with mobile no and OTP. However, it is understood that the user may also register with the customer-merchant system 120 using a website with mobile no and OTP. The user may get credit points for sign up and receives referral coupon automatically in his/her account. It is understood here that the user needs to submit/upload his/her bank account details, scanned and self attested government issued official documents related to bank account for verification and approval. On approval, the account gets activated for credit to his/her bank account. Further, it is understood that user is able to update his/her bank account details subject to verification and approval. The user is able to delete his/her bank account from the system.

In the context of the present invention, the consumer is facilitated to shop through the customer-merchant transaction system 120 wherein shopping is facilitated with coupon or without coupon. In shopping with coupon, the user identifies registered merchant for shopping through an inbuilt merchants' directory and makes a direct purchase. It is understood here that the consumer makes the direct purchase with the registered merchant at his/her physical shop or online shop. However, the consumer may or may not receive a special upfront discount from merchant during such purchase. Accordingly, the consumer receives predefined number of referral coupons having a predefined reward/commission value to distribute via application to his/her connects/contact list/social media. Subsequently, the consumer asks for coupons to his connect/contact list/social media using search based filtering. In shopping with coupon, the consumer makes direct purchase with the merchant at his physical shop or online shop. However, the consumer may or may not receive a special upfront discount from merchant during such purchase. Accordingly, the consumer receives predefined number of referral coupons having a predefined reward/commission value to distribute through the customer-merchant transaction system 120.

In an embodiment, the consumer/user is allowed to view, respond and earn points through the customer-merchant transaction system 120 wherein the user can view the list of running advertisement campaigns directly through advertising merchants' list or directly navigate to a particular advertisement(s) through related notification(s). The user may either respond by reading/viewing/listening to the advertisements or respond appropriately to the predefined objective/subjective questions. The customer-merchant transaction system 120 allows the consumer to earn credit points after receiving correct answers to such questions from the user. In such case, the consumer is asked to share the advertisement to any of his connects inside the system or on social media. This allows the user to receive additional predefined reward points. However, the user is prevented from earning redeemable credit points through the consumer-merchant transaction system 120 after receiving wrong answers to such questions from the user. In such case, the user is prevented from sharing the advertisement to any of his connects inside the system or on social media. This prevents the user from receiving additional predefined reward points through the consumer-merchant transaction system 120. In one embodiment, the consumer-merchant transaction system 120 allows the referrer to receive credit points for each successful sell through distributed/shared referral coupons. Preferably, the registered user receives predefined credit points for each correct answer on interacted advertisements. In such case, the registered user receives credit points for each shared advertisement to his/her connects/contact list/on social media.

In an embodiment, the customer-merchant transaction system 120 facilitates redemption of the earned points for the customer thereby allowing payment of utility bill/mobile/DTH and/or other recharges via the payment gateway/s 192. Alternatively, the customer-merchant transaction system 120 facilitates redemption of the earned points thereby crediting cash to bank account of the consumer after giving effect of applicable taxes. Alternatively, the customer-merchant transaction system 120 facilitates redemption of the earned points partially/fully at the merchant outlet.

In one embodiment, the customer-merchant transaction system 120 facilitates browsing of merchants such that the registered merchants can be browsed based on current location/proximity. The customer-merchant transaction system 120 applies filters to narrow down the search for merchants. Accordingly, the customer is allowed to view all relevant information published by the merchant like discover offers/photos/menu and the like. Alternatively, the customer is also allowed to view all relevant information published by the other registered users like generic or specific ratings/reviews and the like.

In an embodiment, the customer-merchant transaction system 120 facilitates the consumer to give review rating wherein the consumer is allowed to write a feedback or review about a merchant and/or product, in objective or subjective manner, only after at least one successful purchase transaction through the system, with that particular merchant.

In one embodiment, the customer-merchant transaction system 120 facilitates generation of credit points report based on credit points earned through either referrals or advertisements. The customer-merchant transaction system 120 facilitates generations of history report received referral coupons received, expired referral coupons, referral Coupons requests received, referral coupons responses received against requests, utility payments made and transactions done through the customer-merchant transaction system 120.

In an embodiment, a merchant registration procedure with the customer-merchant transaction system 120 in accordance with the present invention is described wherein the merchant preferably performs registration through a mobile application such that the merchant downloads, installs and registered with mobile number and OTP for signing up. Alternatively, the merchant can registered with the customer-merchant transaction system 120 through a desktop application followed by registration and logging in with mobile number and OTP. The merchant preferably submits/uploads scanned and self attested, government issued official documents related to business for verification and approval to the customer-merchant transaction system 120. On approval, an account for the merchant gets activated for further configuration. However, it is understood here that the merchant needs to configure his/her business/merchandise account wherein the merchant fills up required business profile information including but not limited to, various discount schemes/referral credits schemes and/or special offers for customers. Alternatively, the merchant fills up business profile information for franchise stores or sub stores thereby creating respective separate accounts for daily operations. This ensures that coupon from main merchant is honored across his franchise/sub stores.

In the context of the present invention, the merchant is facilitated to sale through the customer-merchant transaction system 120 wherein sale is subjected with coupon or without coupon. In case of sale without coupon, the customer approaches without coupon and a direct sale is initiated wherein the merchant makes direct sale to the customer through physical shop or online shop. However, it is understood here that the merchant may or may not give a special upfront discount to consumer. The merchant preferably sends a predefined message with a link to customer to download the application such that customer automatically receives predefined number of referral coupons having a predefined reward/commission value to distribute in customer's account. In case of sale with coupon, the customer approaches with a coupon wherein the merchant makes a direct sale to the customer through physical shop or online shop by either scanning the related coupon's QR code or by entering customer's mobile number in to the system and selecting related coupon. However, it is understood here that the merchant may or may not give a special upfront discount to consumer. In such case, the customer automatically receives predefined number of referral coupons in his/her account, having a predefined reward/commission value to distribution.

In an embodiment, the customer-merchant transaction system 120 facilitates announcements/notifications for customers wherein the merchants are able to send multiple/time interval based/occasion based notifications to their customers, who have transacted through the system using various filters such as duration, transaction ticket size, referrals and ratings. For example, the merchant is allowed to make announcements/notifications as per duration for customers who did not transact for various periods such as 1 month/3 months and so on. The merchant is allowed to make announcements/notifications as per transaction ticket size for customers who transacted above or below a certain amount. The merchant is allowed to make announcements/notifications as per referrals for customers who are highest or lowest referral givers. The merchant is allowed to make announcements/notifications as per ratings for customers who have given highest or lowest review ratings.

In an embodiment, the customer-merchant transaction system 120 facilitates reports for the merchant such as credit point reports given through referrals, credit point given through advertisements and historical data reports. The historical data reports preferably includes own outlet/franchise stores or sub stores which may include reports such as accepted referral coupons, given referral coupons, transactions happened through the system based on various predefined filters, payments record inclusive of taxes which are payable and paid to the system based on various predefined filters, customer shopping behavior tracking based on transactions, customers ratings report based on various predefined filters, referrers report based on ranking and activity, complaints and grievances resolution, suggestions/feedback report, advertisement viewership and engagement reports based on various predefined filters, enquiry/lead generation report and the like.

In one embodiment, the customer-merchant transaction system 120 facilitates creation and configuration of advertisement for the merchant wherein the customer-merchant transaction system 120 allows the merchant to set budget for the advertisement and sets reward points for each correct answer given by the registered user. The customer-merchant transaction system 120 allows the merchant to set reward points for each social media sharing done by the registered user. The customer-merchant transaction system 120 allows the user to get the target users based on location and/or interests and/or other identical filters. The customer-merchant transaction system 120 allows the merchant to display estimated views depending upon the budget and the targeted user reach. The customer-merchant transaction system 120 allows the merchant to push advertisement thereby setting start and end date for the advertisement campaign. The customer-merchant transaction system 120 allows the merchant to add schedule for inclusion or exclusion on specific dates. The customer-merchant transaction system 120 allows the merchant to set social sharing text with related hash tag (#) or alike. The customer-merchant transaction system 120 allows the merchant to set predefined number of questions and their objective answers and also mark the correct answer. The customer-merchant transaction system 120 allows the merchant to review the advertisement based on the inputs set. The customer-merchant transaction system 120 allows the merchant to proceed for the payment such that the advertisement goes into moderation for final approval and goes live thereafter upon successful payment.

The customer-merchant transaction system 120 facilitates the merchant to manage/edit advertisement wherein the merchant is allowed to view the list of all advertisements pushed through the system and make desired changes in current or upcoming advertisements followed by sending for final approval. The customer-merchant transaction system 120 facilitates the merchant to extend advertisement campaign wherein the date(s) for any already approved advertisement(s) are allowed to be extended followed by proceeding for the payment without any need of re-approval.

The customer-merchant transaction system 120 facilitates the merchant to generate advertisement reports wherein the advertisement reports mainly include reports such as advertisement viewership and engagement reports based on various predefined filters, enquiry/lead generation report, payment Reports based on various filters and the like.

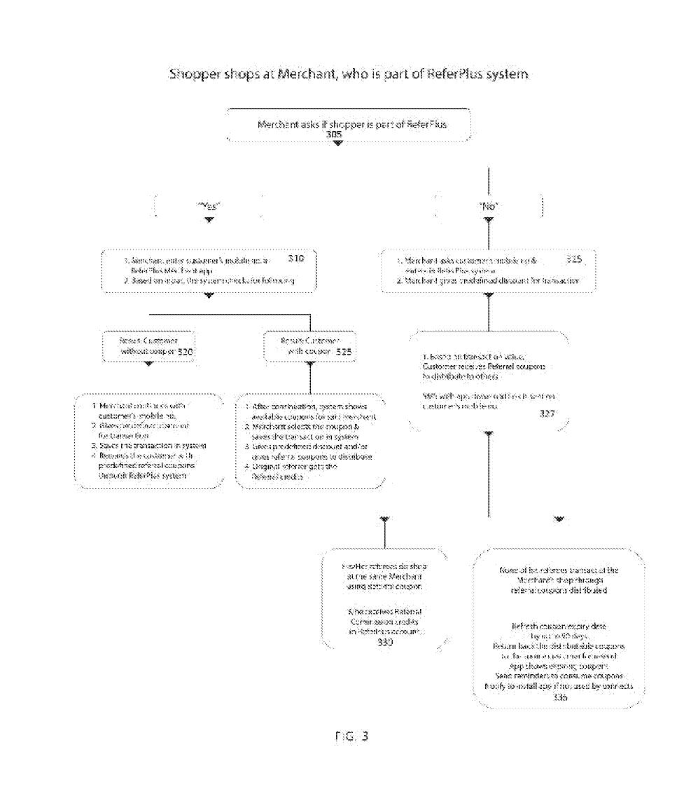

Referring to FIG. 3 shows a flow chart of a transaction method of a customer with a merchant using a customer loyalty and rewards platform, according to one embodiment of the present invention. At step 305, the merchant asks if the shopper is a part of the customer-merchant transaction system 100 or 200 such that the process follows a step 310 if the answer is YES else the process follows a step 315 if the answer is NO. In step 310, the merchant enters mobile number of the customer in the customer-merchant transaction system 120 through a merchant application based on the input and accordingly the customer-merchant transaction system 120 checks if the result is customer without coupon or customer with coupon in respective steps 320 and 325. In step 320, the merchant continues with customer's mobile number and gives predefined discount for the transaction. In step 320, said transaction is saved in the customer-merchant transaction system 120 to reward the user/customer with predefined referral coupons through the customer-merchant transaction system 120. In step 325, the customer-merchant transaction system 120 shows available coupons for the predefined merchant such that the merchant selects the coupon and saves the same in the customer-merchant transaction system 120. In this step 325, the customer-merchant transaction system 120 gives predefined discount and/or referral coupons for distribution and original referrer is awarded with referral credits. In step 315, the merchant asks customer's mobile number and accordingly enters the same in the customer-merchant transaction system 120 such that the merchant gives predefined discount for said transaction. In next step 327, the customer-merchant transaction system 120 facilitates the customer to receive referral coupons to distribute to others based on transaction value and accordingly an SMS with application download link is sent on registered mobile number of the customer/user. In step 330, referees of the customer do shopping at the same merchant using the referral coupon such that referees receive referral commission credits through the customer-merchant transaction system 120. Alternatively, in step 335, if none of the referees of the customer transact through merchant's shop through the distributed referral coupons then referral coupons get expired after 90 days period. In such case, the distributed coupons need to be returned back to the source customer for resend. It is understood here that the customer-merchant transaction system 120 shows such expired coupons and accordingly sends reminders for consumption thereof.

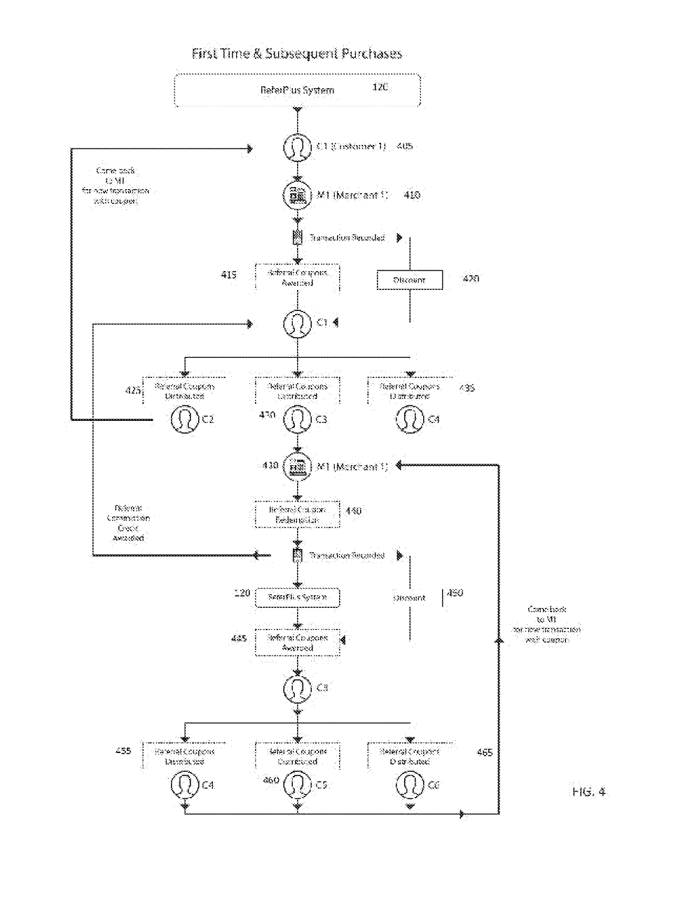

FIG. 4 shows an example flow chart of FIG. 3 where the customer does a transaction with a merchant for the first time and subsequent purchase, according to one embodiment of the present invention. In an operation, the customer C1 make a purchase transaction at a merchant M1. The transaction is recorded and the customer C1 is provided with one or more referral coupons. Using the coupons, the customer C1 distribute to other customer i.e. C2, C3 and C4. In an example embodiment, the customer C3 makes a transaction with the same merchant i.e. M1 using the coupon (where the coupon is received from customer C1), the referral coupon redemption takes place and the transaction is recorded. The customer C3 is provided by one or more referral coupons issued by the system. In a similar manner the chain of referral and redemption process grows from customers to the merchant.

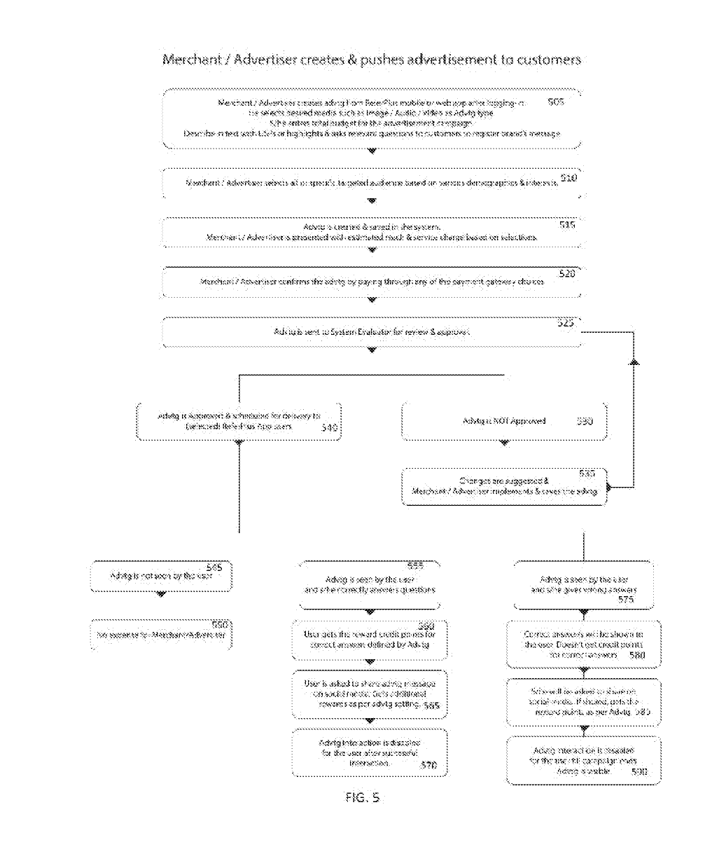

FIG. 5 shows a flow chart of a method of pushing information to and receiving information to a target customers from a platform over a communication network, according to one embodiment of the present invention. An advertisement creation process by a merchant/advertiser and a process of pushing the same to customers using the customer-merchant transaction system is shown. At step 505, the merchant/advertiser creates an advertisement from the customer-merchant transaction system using a mobile or web application after logging in to the customer-merchant transaction system. In this step, the merchant/advertiser selects desired media for the advertisement such as an image, an audio or a video. In this step, the merchant/advertiser enters total budget for the advertisement campaign. It is understood here that the merchant/advertiser describes the text of advertisement with USPs and/or highlights and asks relevant questions to customers to register brand's message. In next step 510, the merchant/advertiser selects all or specific targeted audience based on various demographics and interests of the customer. In further step 515, an advertisement is created and saved in the customer-merchant transaction system and subsequently the merchant/advertiser is presented with estimated reach and service charge based on selections made by the customer. In next step 520, the merchant/advertiser confirms the advertisement thereby paying through any of the payment choices through the payment gateway. In next step 525, the advertisement is sent to the system configurator for review and approval thereby communicating with system configuration database. If the advertisement is unapproved then the process moves to step 530 such that the merchant/advertiser suggests changes and saves the advertisement in the unapproved advertisement in next step 535 which is returned back to earlier step 525. However, if the advertisement is approved then the process moves to a step 540 wherein approved advertisement is scheduled for delivery to predefined users of the customer-merchant transaction system. The process moves to a step 545 in case where the advertisement is not seen by the user and accordingly in step 550, no expenses for merchant/advertiser are charged by the customer-merchant transaction system. Alternatively, if the advertisement is seen by the user/customer and he/she correctly answers the questions asked by the customer-merchant transaction system then the process moves to a step 555. In next step 560, the user/customer gets the reward credit points for the correct answers defined by the advertisement. In next step 565, the user is asked to share the advertisement message on social media in order to get additional rewards as per advertisement settings. In next step, the advertisement interaction is disabled for the user after successful interaction with the customer-merchant transaction system. Alternatively, if the advertisement is seen by the user/customer and he/she gives wrong answers then the process moves to a step 575. In next step 580, the customer-merchant transaction system shows correct answers to the user and in this step the user is prevented from getting reward points for the correct answers. In next step 585, the customer/user is asked to share credit points on social media such that the user gets reward points as per advertisement if the customer/user shares reward points. In next step 590, the advertisement interaction is disabled for the user till campaign ends and according the advertisement is made visible on the customer-merchant transaction system.

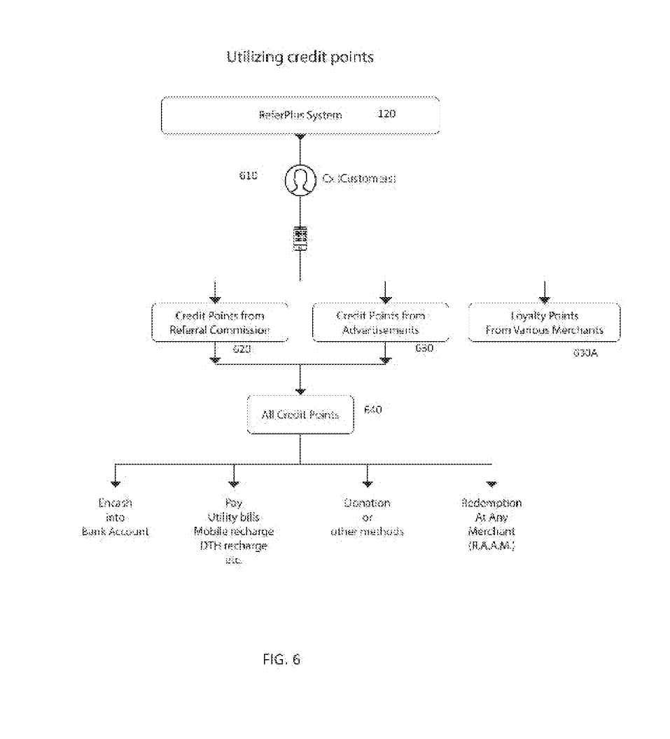

FIG. 6 shows an example flow chart of utilization of credit points by the customers using the customer-merchant transaction system of FIG. 1, according to one embodiment of the present invention. Referring to FIG. 6, a process of utilization of credit points by the customers using the customer-merchant transaction system is shown wherein the customer-merchant transaction system communicates with a plurality of customers 610 through a mobile application or web application such that credit points and loyalty points are earned either from referral commission in step 620 or from advertisements in step 630 or from various merchants. The credit points earned in steps 620, 630 are added in step 640 that can be utilized for a plurality of purposes such as for encashment into bank account, payment of utility bills, mobile recharge, DTH recharge, donation, redemption at any merchant (R.A.A.M) and the like.

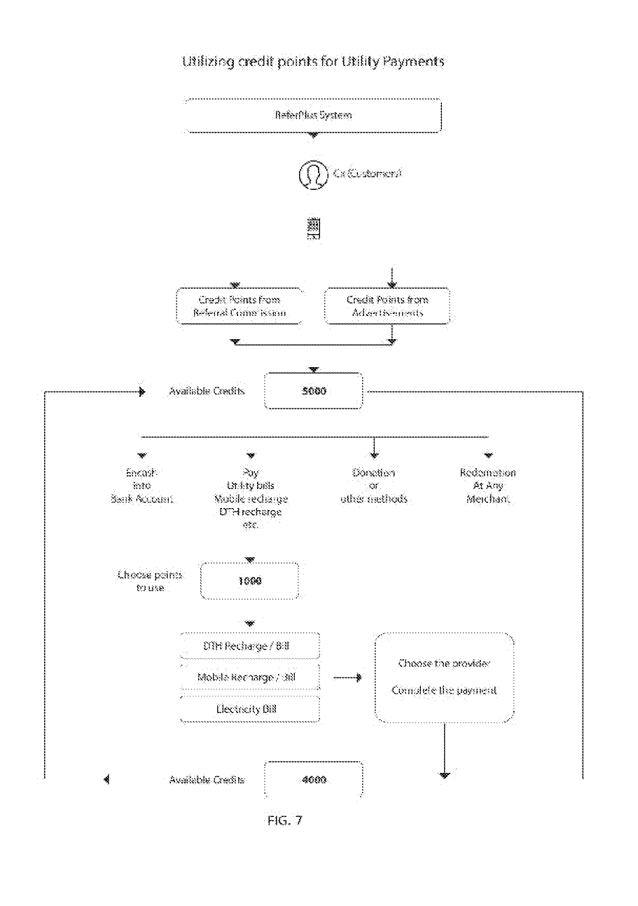

FIG. 7 shows an example flow chart of utilization of credit points for utility payments by the customer, according to one embodiment of the present invention. In this example, the customer has accumulated credits of 5000 points which comes from both referral commission and advertisements. With the credit point of 5000, one can encash the same into bank account, one can pay utility bills e.g. mobile recharge, DTH recharge etc, one can make a donation and also one can redemption the same at any merchant. In this example, the customer has made a choice of making utility payments with 1000 credit points. The customer choose the service provide whether may be DTH recharge, mobile recharge, electricity bill and complete the process of payment. With the usage of 1000 credit points at the utility payments, available credit remain with the customer i.e. 4000 credit points.

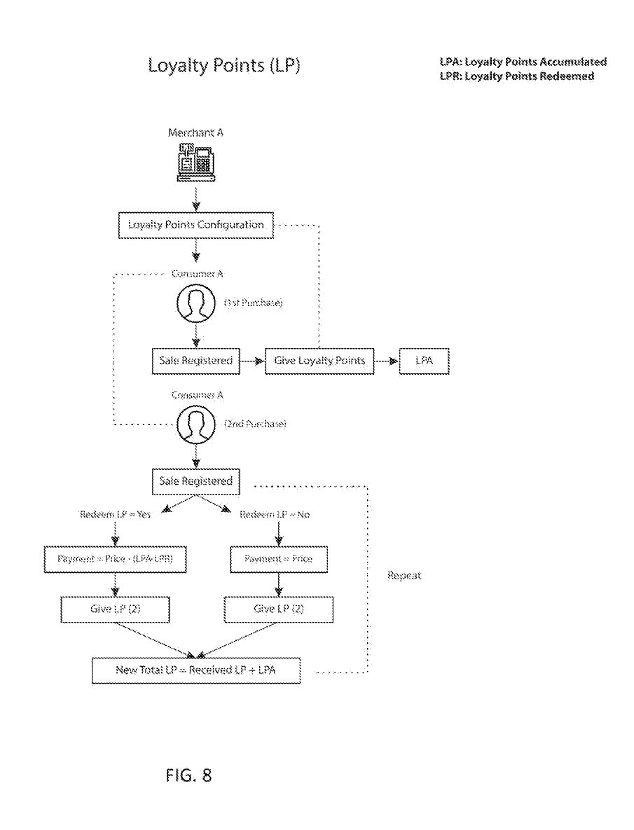

FIG. 8 shows an example flow chart of allocation of system loyalty points, according to one embodiment of the present invention. The system have integrated unified Loyalty Points for all the merchants. These loyalty points are different from the Credits received by each consumer. In an example, the merchant may offer predefined loyalty points to the consumer after every purchase, in addition to the discounts and/or referral credits. These loyalty points can be accumulated in the customer system account. These loyalty points can be redeemed only at that specific merchant(s), in exchange for the goodies which are predefined by the merchant(s).

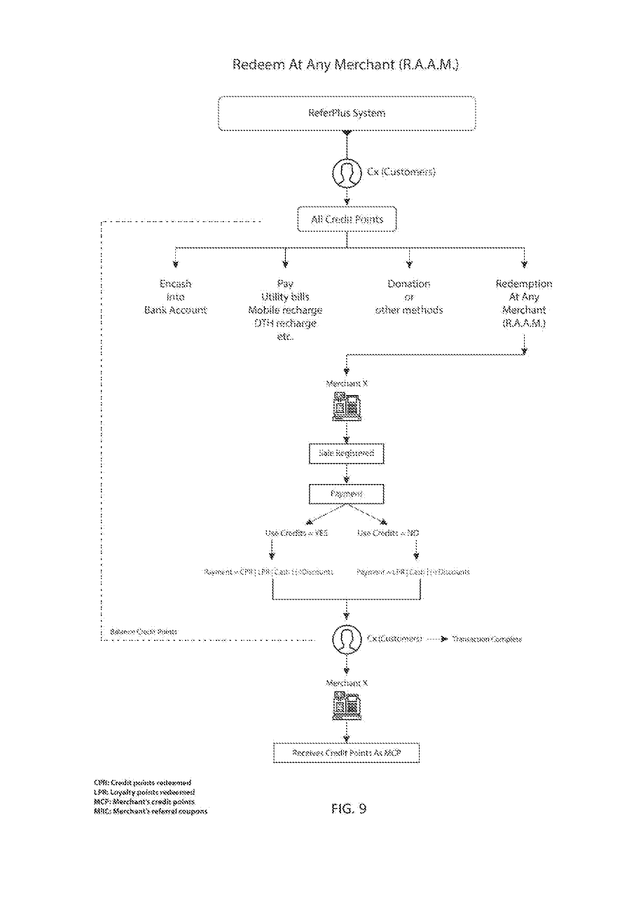

FIG. 9 shows an example flow chart of redemption of the credit points by the customer with respect to any merchant, according to one embodiment of the present invention. All the Referral Credits, Advertising Credits which are “Available For Use”, in the consumer's system account, which can be redeemed partially or fully at any merchant outlet. This feature is available in addition to encashing these credit points to the bank or, using these credits to pay for Utility Payments as described above. For example, the Consumer A receives the Credit Points after the Merchant A paid for the invoice generated by system. Then the Consumer A uses his/her credit points at Merchant B outlet, instead of encashing them into his/her bank account linked with the system. These Credit Points are honored by the Merchant B and considered as a payment for the goods or services purchased by Consumer A. System will award a Credit Note to the Merchant B worth the amount honored as credit points. Which means, system will provide discount and/or by reimbursement payment, equal to those credit points, in every applicable future invoice(s).

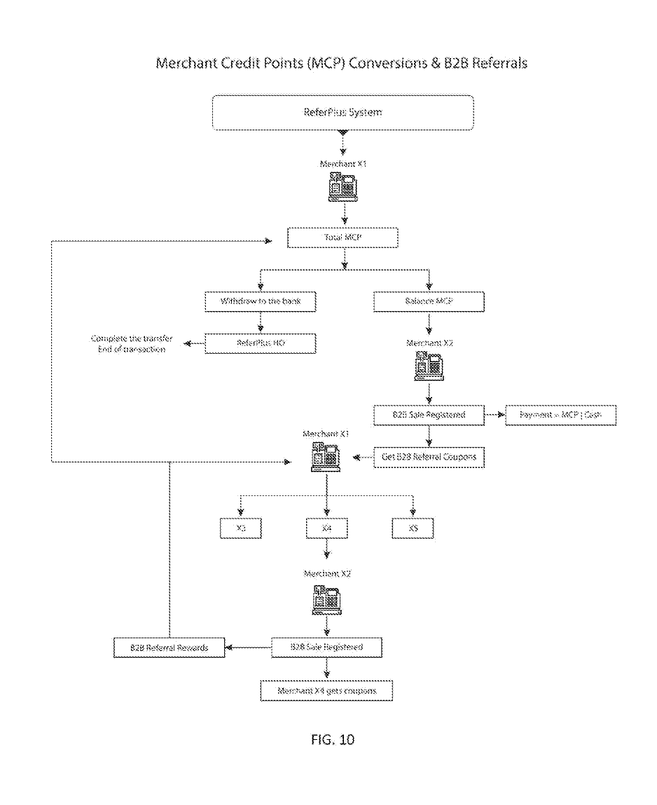

FIG. 10 shows an example flow chart of conversion of merchant credit points, according to one embodiment of the present invention. The MCP i.e. Merchant credit points are similar to the user's credit points but mainly for the referrals that happen from business to business. As shown in the figure, the merchant will be the B2B referrer. The merchant can decide how to use those earned merchant credit points. Merchant can withdraw these points via bank transfer or use them for business purchases at other registered businesses. The merchants will earn these MCPs by accepting credit points as payment from the customers and or by B2B referral rewards through distributed B2B coupons & successful sale from them.

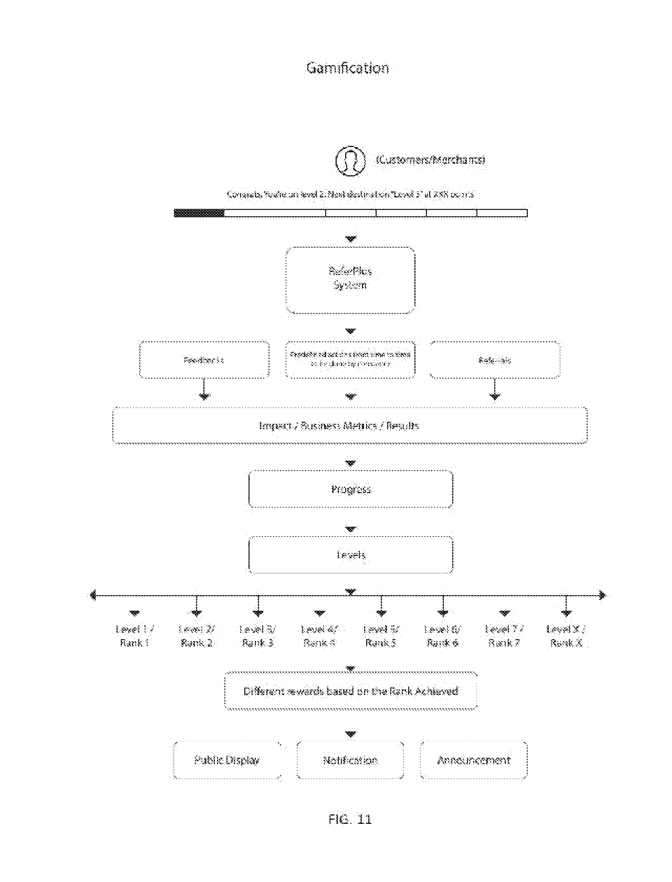

FIG. 11 shows an example flow chart of ranking process of the customer by the merchant, according to one embodiment of the present invention. For every customer-merchant transaction, the system provides a ranking system based on completion of assigned number of tasks (i.e. if the total number of coupons distributed to the customer is redemption successfully, then the customer is provided with some rank or position). After reaching to the preassigned number of tasks (for example 5 coupons issued and redemption has been completed), the customer will get promoted to the next level & will have a new designation/rank. Every customer or merchant or both while siging up with the system, the customer and merchant will be on Level 1 or on a specified first designation/rank. Every new rank has got various designated rewards. In addition to this, the customer on top of the rank or charts will receive special rewards from the merchants. Such as: Most Referrals in A Month (Best Business Giver), Most Referrals In A Year & so on.

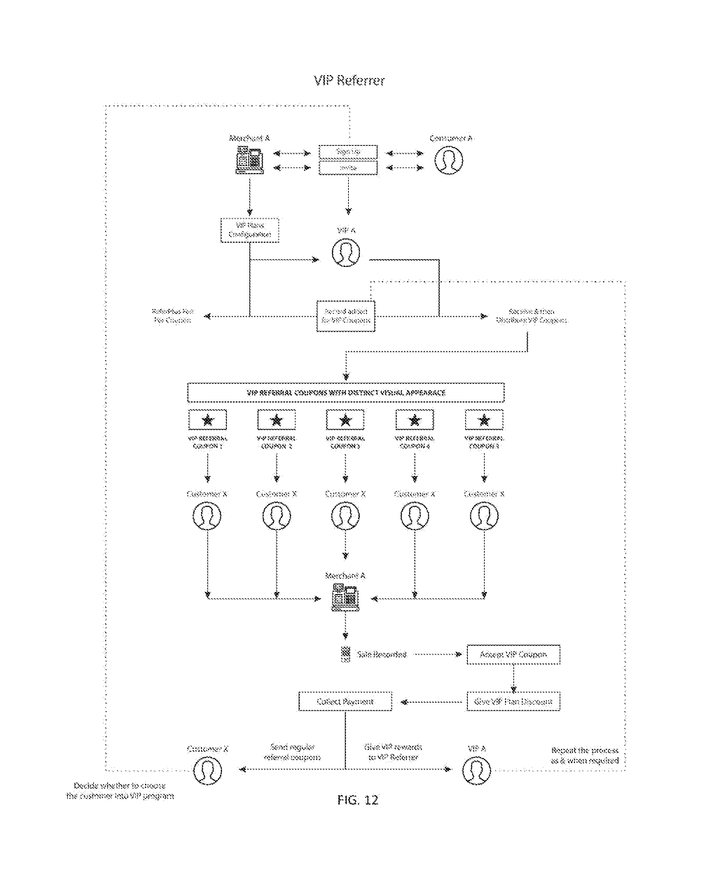

FIG. 12 shows an example flow chart of allocation of VIP referrer by the merchant, according to one embodiment of the present invention. In the system, every merchant can invite and/or ask their consumers to apply & become their VIP (very important person) referrer. The selection of such VIP Referrer based on various parameters such as: number of sales, number of referrals & the existing network of the consumer etc. In an example embodiment, the VIP Referrer will have coupons with distinguishable different color/coding which he/she can pass on. These VIP coupons may offer more discounts, more referral credits, special offers and/or special services as determined by the merchant. VIP Referrer will not be required to make purchases, to be able to receive Distributable Coupons. The designated merchant will generate predefined number of coupons and award the same, as and when necessary. This will further help the merchants in generating more sales or reach out to new people by taking assistance from the VIP Referer & his performance in the past. In case of VIP Referer—the system will bill the merchant for each generated VIP coupon instead of charging for each registered sale.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the spirit or scope of the present invention.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

FIGS. 1-12 are merely representational and are not drawn to scale. Certain portions thereof may be exaggerated, while others may be minimized. FIGS. 1-12 illustrate various embodiments of the invention that can be understood and appropriately carried out by those of ordinary skill in the art.

1. A transaction method of a customer with a merchant using a customer loyalty and rewards platform, the method comprising:
receiving a purchase request for at least one product from the customer by the merchant;
checking the received request by the merchant, whether the customer is a registered user of the platform for availing the service of the platform;
entering one or more information of the customer by the merchant in the platform;
checking whether the customer is with a coupon or without a coupon for transacting the purchase request based on the information provided by the customer;
assigning predefined discount for the transaction and provides predefined referral coupons through the portal, if the customer is performing a transaction without a coupon; and
displaying available coupons with the customer for the corresponding merchant and provides further discount and/or referral coupons for distribution, if the customer is performing a transaction with a coupon.

2. The method of claim 1, wherein the step of checking the received request by the merchant further comprising:
requesting the customer to provide one or more information by the merchant in the platform;
providing predefined discount for the transaction to the customer and further provides referral coupons to distribute to other unknown customers; and
crediting referral commission credits or points if any of the unknown customer uses the distributed coupons with the same merchant.

3. The method of claim 2, further comprising:
refreshing coupon expiry information and forwarding one or more notification about the same to the referee and the platform.

4. A method of pushing information to and receiving information to a target customers from a platform over a communication network, the method comprising:
receiving by the platform, from at least one merchant, an advertisement and conditions for publishing the advertisement to one or more customers, wherein the advertisement includes a plurality of questions about a brand or a product or likewise;
getting one or more reward points to the customer for all correct answers;
requesting the customer to share the advertisement message on various social media network to earn addition rewards as per the advertisement setting; and
disabling the advertisement interaction with the customer once the advertisement message is shared.

5. The method of claim 4, further comprising:
receiving one or more advertisement including the plurality of question by the customer from the platform;
displaying all the answers to the question upon determining the customer has provided wrong answers to the questions;
requesting the customer to share the advertisement message on various social media network to earn rewards as per the advertisement setting; and
disabling the advertisement interaction with the customer once the advertisement message is shared.

6. The method of claim 1 or 4, wherein with the credit point collected from the referral commission, advertisement and loyalty points is available for redemption partially or wholly to various activities including encash into bank account of customers, pay utility bills, mobile recharge, donation, or at any merchant who are all associated with the portal.

7. The method of claim 1 or 4, wherein the platform identifies the customer to rank them based on the number of tasks completed on various activities and reward them based on the rank achieved, wherein the activities includes upon registration of the customer with the portal, conversion of referrals, answering all the questions in the advertisement, publishing the advertisement in the social media etc.

8. The method of claim 1 or 4, wherein the merchant invites the customer to become their referrer with VIP tag, wherein the selection of the VIP referrer is based on the number of sales done by the customer, number of referrals grown in the customer network, and wherein the customer with VIP tag having a status symbol and get special discount on various product or service or both.

9. A system for customer loyalty and rewards platform establishment and management of operation, the system comprising:
the platform having a plurality of modules including a merchant module, an administration module, a customer module, a coupon module and a plurality of databases corresponding to the respective modules;
a plurality of merchants and a plurality of customers both having at least one handheld device which are configured with the platform over a virtualized cloud-based system for distributed communication via a communication network;
the platform is operable to receive inputs from at least one consumer user for creating a consumer and a merchant profile registered through the at least one processor and stored in a platform database, the consumer profile including at least a consumer username, contact information, and at least one consumer user payment account registered with the platform, the merchant profile including at least a merchant username, contact information, and at least one merchant recipient account registered with the platform;
the processor operable for automatically sending, activating, and redeeming at least one digital incentive for a financial amount by applying the financial amount as a credit or discount for a predetermined spend activity by the consumer at a registered merchant within the platform.

10. The system of claim 9, wherein the handheld device is selected from a tablet computer, a smartphone, a laptop computer, and combinations thereof.

11. The system of claim 9, wherein a mechanism for automatically registering the consumer at least one payment card account with the platform, wherein the mechanism receives information for the at least one payment card account at a point of sale (POS) when the consumer presents the at least one payment card account for making electronic payment for goods and/or services at the POS.

12. The system of claim 9, wherein the mechanism is a POS payment device.

13. The system of claim 9, wherein the platform is operable for receiving by the at least one processor, storing and analyzing in the database, the consumer users' spend data and product and/or services included in each purchase.

14. The system of claim 9, wherein the database stores consumer users' spend data, including product and/or services for each purchase.

15. The system of claim 1, wherein the consumer profile is automatically associated with at least one digital incentive for redemption with at least one merchant registered within the platform.

16. The system of claim 1, wherein each consumer is automatically and immediately enrolled with merchant loyalty programs for all merchants registered with the platform following initial registration for the consumer.
